(19) United States
(12) Patent Application Publication
(10) Pub. No.: US 2025/0089681 A1
(43) Pub. Date: Mar. 20, 2025

(54) ANIMAL BEHAVIOR CORRECTION DEVICE, METHOD, AND SYSTEM

(71) Applicant: INVENTEC APPLIANCES CORPORATION, New Taipei City (TW)

(72) Inventor: JIAN MA, Nanjing (CN)

(21) Appl. No.: 18/624,052

(22) Filed: Apr. 1, 2024

(30) Foreign Application Priority Data
Sep. 14, 2023 (CN) 202311188710.7

(51) Int. Cl. A01K 15/02; A01K 11/00; A01K 29/00

(52) U.S. Cl. CPC A01K 15/029; A01K 11/006; A01K 29/005

(57) ABSTRACT

Animal behavior correction device, method, and system are provided in the present disclosure. The animal behavior correction device is worn on an animal to be detected and includes a positioning module, a memory module, a physiological data acquisition module, a main control module, and a correction module. The positioning module acquires location data of the animal and defines location data of a safe area. The memory module acquires basic data of the animal. The physiological data acquisition module acquires physiological data of the animal. The main control module determines whether or not the animal is located in the safe area based on the first location data of the animal and the second location data of the safe area. When the animal is not located in the safe area, the main control module generates a correction operation and a correction intensity of the correction operation.

### CROSS-REFERENCE TO RELATED PATENT APPLICATION

This application claims the benefit of priority to China Patent Application No. 202311188710.7, filed on Sep. 14, 2023, in the People's Republic of China. The entire content of the above identified application is incorporated herein by reference.

### FIELD OF THE DISCLOSURE

The present disclosure relates to a field of automated animal husbandry, and more particularly to an animal behavior correction device, method, and system.

### BACKGROUND OF THE DISCLOSURE

In the existing animal husbandry, grazing of pastures usually requires the installation of fences to better manage animals and the pastures, and to reduce pollution and damage by animals to surrounding environments such as water sources. However, a traditional grazing method that uses manual labor to set up the fences incurs high costs in both manpower and material resources, making it inconvenient for locations of the fences to be changed frequently. Moreover, many countries around the world have very large areas of pasture, making it even more inconvenient to change the locations of the fences.

### SUMMARY OF THE DISCLOSURE

In response to the above-referenced technical inadequacies, the present disclosure provides animal behavior correction device, method, and system.

In order to solve the above-mentioned problems, one of the technical aspects adopted by the present disclosure is to provide an animal behavior correction system. The animal behavior correction system includes an animal behavior correction device, a server terminal, and a user terminal. The animal behavior correction device acquires first location data, basic data, and physiological data of an animal and defines second location data of a safe area. The animal behavior correction device is configured to determine whether or not the animal is located in the safe area based on the first location data of the animal and the second location data of the safe area, and generate a correction operation and a correction intensity of the correction operation at least based on the basic data and the physiological data when the animal is determined to not be located in the safe area; and the animal behavior correction device is configured for behavioral correction of the animal based on the correction operation and the correction intensity, such that the animal at least returns to the safe area. The animal behavior correction device transmits at least the first location data, the basic data, the physiological data, the correction operation, and the correction intensity of the animal to the server terminal through a first communication system, and the server terminal then transmits the first location data, the basic data, the physiological data, the correction operation, and the correction intensity. The user terminal receives the first location data, the basic data, the physiological data, the correction operation, and the correction intensity from the server terminal.

### BRIEF DESCRIPTION OF THE DRAWINGS

The described embodiments may be better understood by reference to the following description and the accompanying drawings, in which:

FIG. 1 is a schematic structural diagram of an animal behavior correction device according to the present disclosure;

FIG. 2 is another schematic structural diagram of the animal behavior correction device according to the present disclosure;

FIG. 3 is a flowchart of an animal behavior correction method according to the present disclosure;

FIG. 4 is a flowchart of sequentially executing four correction operations according to the present disclosure;

FIG. 5 is a schematic structural diagram of an adjustable discharge control system according to the present disclosure;

FIG. 6 is a flowchart of an animal behavior correction method for animal fighting according to the present disclosure;

FIG. 7 is another flowchart of the animal behavior correction method for animal fighting according to the present disclosure;

FIG. 8 is a flowchart of an animal behavior correction method for lost animals according to the present disclosure; and

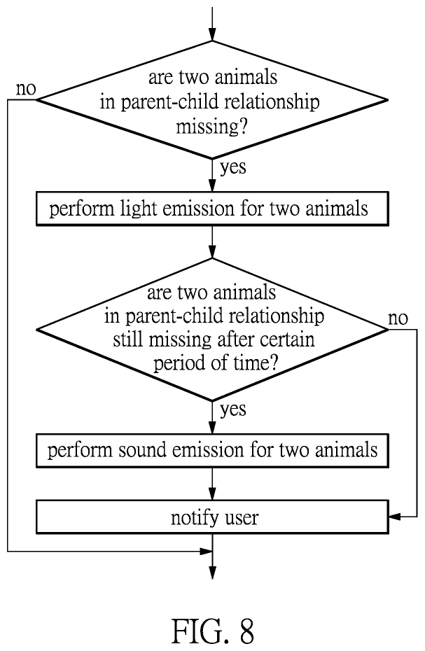

FIG. 9 is a schematic view of an animal behavior correction system according to the present disclosure.

### DETAILED DESCRIPTION OF THE EXEMPLARY EMBODIMENTS

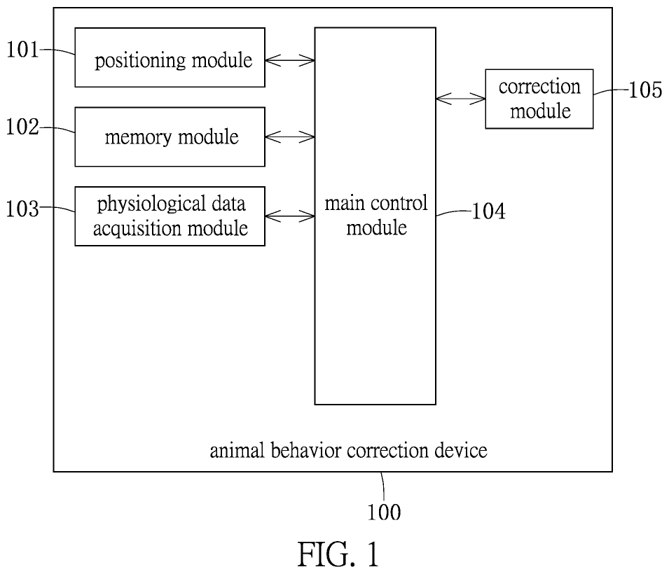

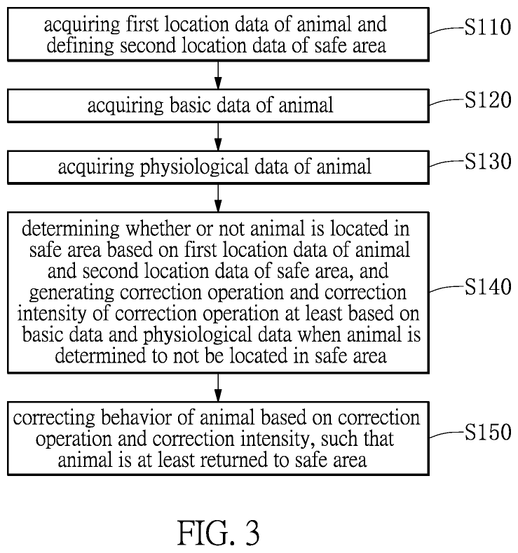

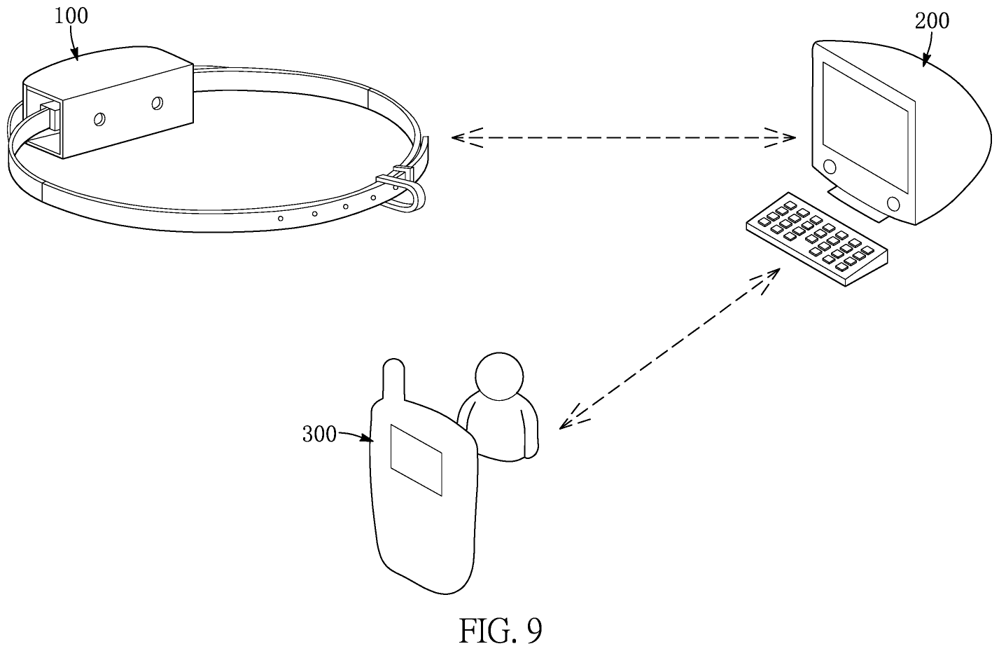

FIG. 1 is a schematic structural diagram of an animal behavior correction device according to the present disclosure, FIG. 3 is a flowchart of an animal behavior correction method according to the present disclosure, and FIG. 9 is a schematic view of an animal behavior correction system according to the present disclosure. Referring to FIG. 1, FIG. 3, and FIG. 9, the present disclosure provides an animal behavior correction device, an animal behavior correction method, and an animal behavior correction system. An animal behavior correction device 100 is worn on an animal to be detected and includes a positioning module 101, a memory module 102, a physiological data acquisition module 103, a main control module 104, and a correction module 105. The positioning module 101 is configured to acquire first location data of the animal and define second location data of a safe area. The memory module 102 is configured to acquire basic data of the animal. The physiological data acquisition module 103 is configured to acquire physiological data of the animal. The main control module 104 is configured to determine whether or not the animal is located in the safe area based on the first location data of the animal and the second location data of the safe area. When the animal is not located in the safe area, the main control module 104 generates a correction operation and a correction intensity of the correction operation based on at least the basic data and the physiological data. The correction module 105 is configured for behavioral correction of the animal based on the correction operation and the correction intensity, so as to at least return the animal to the safe area.

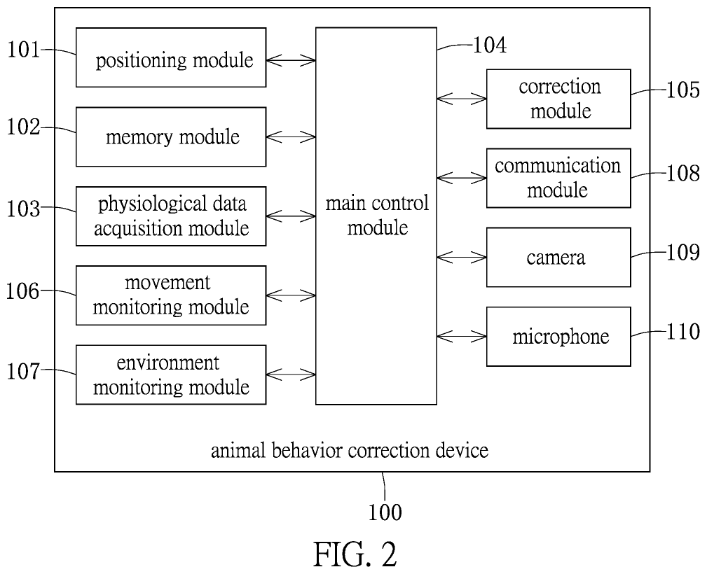

FIG. 2 is another schematic structural diagram of the animal behavior correction device according to the present disclosure. As shown in FIG. 1 to FIG. 3, one embodiment of the present disclosure provides the animal behavior correction device 100. The animal behavior correction device 100 includes the positioning module 101, the memory module 102, the physiological data acquisition module 103, the main control module 104, the correction module 105, a movement monitoring module 106, an environment monitoring module 107, a communication module 108, a camera 109, and a microphone 110.

In certain embodiments, the positioning module 101 is configured to acquire first location data of the animal, define second location data of the safe area, and then transmit the first and second location data to the main control module 104. The two pieces of location data are acquired through at least one type of global navigation satellite system (GNSS), but the present disclosure is not limited thereto. The memory module 102 is configured to acquire the basic data of the animal, and then transmit the basic data to the main control module 104. Specifically, the basic data at least includes species, age, gender, electronic identification, and weight. The basic data can be input by the user into the memory module 102, or can be acquired and stored through the device 100. Specifically, after the device 100 is worn by the animal, each animal is assigned an electronic identification according to an electronic identification code of the device 100. Then, through an electronic weighing, the basic data is stored in the memory module 102, and the weight is updated each time. Afterwards, when behavior correction is required, the correction operation and correction intensity can be adjusted according to the weight. For an animal having a weight that is below a certain threshold, milder correction operations and correction intensity are automatically selected. For example, a newborn calf normally weighs between 40 kg and 45 kg and reaches 450 kg at one year old. When the device 100 learns the type and the weight, and when the weight is lower than a preset upper limit of a weight of a juvenile animal of the corresponding type, the device 100 determines that the animal is a calf or a lamb. Therefore, when a correction operation is required, a milder type of the correction operation option such as sound emission or vibration can be selected, and when an electric shock is required, a smaller voltage can be selected for the electric shock.

The physiological data acquisition module 103 is configured to acquire the physiological data of the animal, and then transmit the physiological data to the main control module 104. The physiological data at least includes the heartbeat frequency and a number of swallows made. Through the heartbeat frequency, the number of swallows, and data acquired by other modules, the main control module 104 can preliminarily determine a physiological state of the animal, such as determining if the animal is in a sick state or a pregnant state. The heartbeat frequency can be detected by using a heart rate and blood oxygen sensor. Such data is then sent to the main control module 104 of the device 100 for analysis and recording. The number of swallows can be detected by using a sound sensor or a motion sensor. The sound sensor can be a microphone 110 or other types of sound sensors embedded in the device 100. By analyzing sound patterns and frequencies, the number of swallows can be estimated. The motion sensor detects changes in the throat and head movements as the animal swallows, and the motion sensor can be accelerometers and gyroscopes that can monitor movements in the throat and the head of the animal, and calculate the frequency of swallowing. When the main control module 104 determines that the animal may be in a sick state or a pregnant state based on the heartbeat frequency and the number of swallows, the main control module 104 automatically selects the mild correction operation and correction intensity. When the animal is not located in the safe area, the main control module 104 receives from the positioning module 101 the first location data of the animal wearing the animal behavior correction device 100 and the second location data of the safety area defined by the animal behavior correction device 100. The main control module 104 depicts the second location data of the safe area as an electronic fence on a map, and marks the location of the animal on the map in real-time. When a location of the animal is determined to be outside the electronic fence, the animal behavior correction device 100 determines to perform a correction operation on the animal. The correction operation may sequentially include light emission, sound emission, vibration, and electric shock in an order of from weak to strong according to the correction intensity.

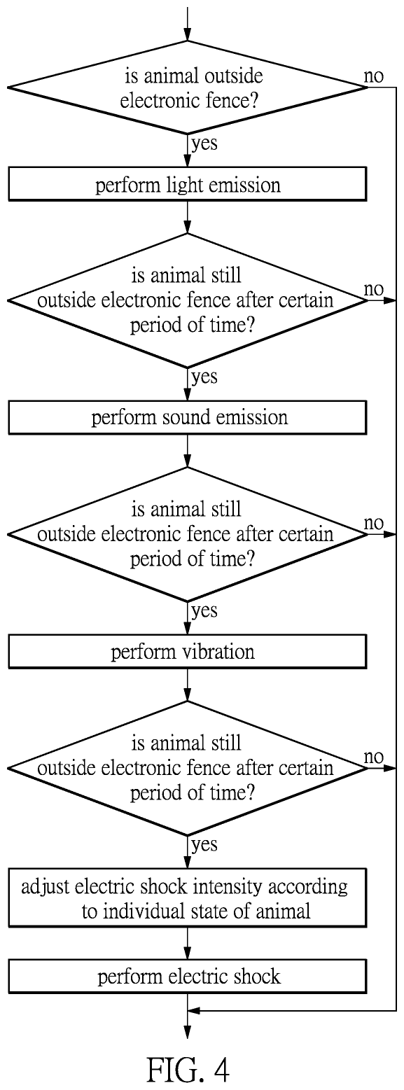

FIG. 4 is a flowchart of an animal behavior correction method for electronic fences according to the present disclosure. As shown in FIG. 4, when the main control module 104 detects that the animal is located outside the electronic fence, the main control module 104 can first use the light emission; when the animal does not return to the electronic fence after a period of time, the main control module 104 can upgrade the correction operation to sound emission; after a period of time has elapsed, if the animal still does not return to the electronic fence, the correction operation can be further upgraded to vibration. The main control module 104 can perform correction operations without following the aforementioned order, or can directly use multiple ones of light emission, sound emission, and vibration at the same time. Since the abovementioned three correction operations cause less harm to the animal, they can be performed directly without considering the actual physiological state of the animal, or they can be performed after the main control module 104 completes the analysis of the physiological state of the animal. However, because of the harmful nature of the electric shock, the intensity of the electric shock must be determined with consideration to the physiological state of the animal before an electric shock operation is performed. If the animal still does not return to the electronic fence within a certain period of time after the vibration, or a combination of the vibration and other correction operations is performed, the main control module 104 will determine to perform the electric shock operation on the animal.

The main control module 104 analyzes the basic data of the animal received from the memory module 102 and the physiological data of the animal received from the physiological data acquisition module 103. According to the basic data of the animal, the main control module 104 can select an electric shock voltage of different intensities for animals of different types, genders, and ages. For example, for a normal weight animal, a voltage of from 5 kV to 15 kV is selected, and 5 discharges are performed for each operation. For animals of a lower weight, a voltage of from 3 kV to 9 kV is selected, and 3 discharges are performed for each operation. The main control module 104 can also determine an eating state of the animal based on the number of swallows of the animal within a period of time so as to determine whether or not the animal is in a hungry state. If the animal is determined to be in the hungry state, the electric shock voltage can also be appropriately reduced. The main control module 104 can further determine a movement state of the animal based on the heartbeat frequency of the animal. For example, when the first location data of the animal shows that the animal gradually moves away from the electronic fence, has a fast movement speed, and has a heartbeat frequency higher than a normal heartbeat frequency, the animal can be determined to be running away from the electronic fence, and the electric shock voltage can be appropriately increased. After any type of correction operation is performed, if the animal is detected to have returned to the electronic fence, the correction operation ends. When the animal again leaves the electronic fence, the main control module 104 performs determination. Then, after the main control module 104 determines the correction operation and correction intensity, the corresponding correction operation and correction intensity are sent to the correction module 105 for being carried out. The correction module 105 can also achieve other correction purposes by receiving instructions from the main control module 104, but is not limited thereto. For the four correction operations transmitted by the main control module 104, the correction module 105 has corresponding physical devices to perform the four correction operations. A light-emitting diode (LED) can be used for the light emission; a speaker can be used for the sound emission; an electric motor can be used for the vibration; and an adjustable discharge control system can be used for the electric shock. In addition to using the light emission and the sound emission as means of correcting an animal behavior, the light emission and the sound emission can also be used as a way to notify a user of abnormalities, thereby enabling the user to easily locate and retrieve animals having abnormal behaviors.

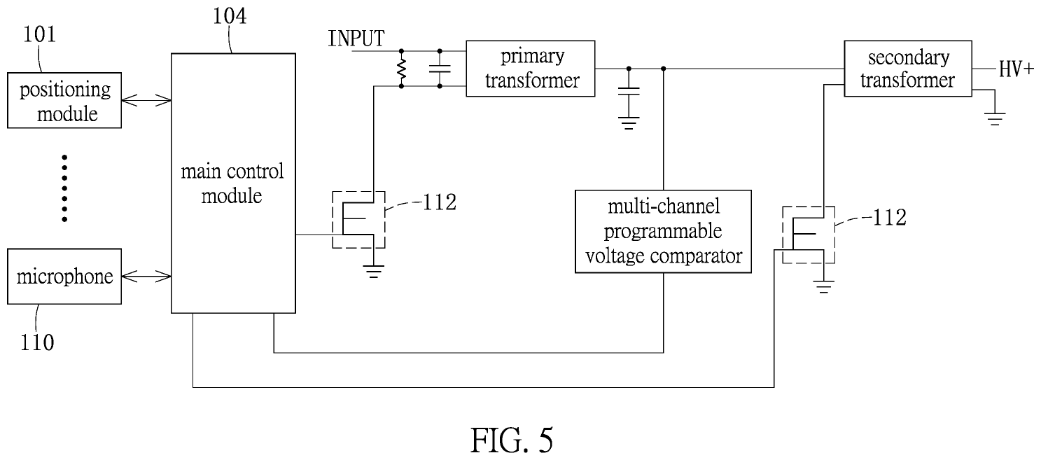

FIG. 5 is a schematic structural diagram of the adjustable discharge control system according to the present disclosure. As shown in FIG. 5, the adjustable discharge control system is used in various steps to control and monitor the discharge process. The system generally includes multiple components such as a primary transformer, a secondary transformer, and a multi-channel programmable voltage comparator. An input voltage of the primary transformer is the operating voltage of the entire system (3.8 V). The function of the primary transformer in the system is to convert the input voltage of 3.8 V into a higher voltage (e.g., from 350 V to 900 V) for subsequent discharge processes. The secondary transformer receives a voltage input from the primary transformer. The function of the secondary transformer is to further increase the voltage according to a ratio of turns of coils of the primary transformer to turns of coils of the secondary transformer, so as to generate a sufficiently high electric field or electric voltage pulse to trigger the discharge phenomenon. A high-voltage voltage HV+ output by the secondary transformer in the system ranges from 3 kV to 15 kV. The secondary transformer outputs different voltages according to different states of the animal. The secondary transformer outputs a voltage of 3 kV as a notification, and outputs a voltage of from 4 kV to 8 kV when the weight of the animal is low. Under normal circumstances, the voltage that is output is from 8 kV to 12 kV, and a voltage of 15 kV is output when the animal is in a fighting state. The multi-channel programmable voltage comparator is used to control the secondary transformer to output different voltages according to different preset threshold voltages. Specifically, a threshold voltage can be preset to be within a certain range. When a voltage to be compared is greater than the preset threshold voltage, the voltage comparator generates an output signal. The output signal can notify the main control module 104, and the main control module 104 then charges a capacitor at an output end of the primary transformer to reach a preset condition. Afterwards, the main control module 104 notifies the adjustable discharge control system to perform the discharge.

The animal behavior correction device 100 further includes the movement monitoring module 106 for capturing movement data of the animal. The movement data can at least include a movement path and an acceleration of the animal, the movement path can be acquired by using the aforementioned global navigation satellite system (GNSS), and the acceleration can be acquired by using an acceleration sensor. In this embodiment, in addition to receiving the first location data, the basic data, and the physiological data of the animal, the main control module 104 also receives movement data of the animal. Therefore, the main control module 104 can perform an accurate analysis based on the aforementioned information. That is, the main control module 104 is further configured to generate the correction operation and the correction intensity based on the movement data. Two examples are described below. In a first example, in response to the weight of the animal decreasing by a magnitude greater than a preset value within a preset time, the number of swallows being less than a preset value within a preset time, and a length of the movement path being less than a preset value within a preset time, the animal is determined to be sick, and the electric shock operation in the correction operation is disabled. It should be noted that the preset value of the length of the movement path can be estimated based on an average number of footsteps taken by an animal group that the animal belongs to over a few recent days. When the animal is determined to be likely in the sick state and the animal leaves the electronic fence, the device 100 automatically disables the electric shock operation to avoid further damage to the animal health caused by the electric shock. Naturally, the device 100 also automatically disables the electric shock operation. In addition, the device 100 can also transmit information regarding the sick state of the animal to a server terminal 200, and the server terminal 200 then transmits the aforementioned information to a user terminal 300 to notify the user, such that the user may then check and treat the animal to ensure the health of the animal. The device 100 can also directly transmit the aforementioned information to the user. In a second example, the animal is determined to be in a pregnant state, and the electric shock operation in the correction operation is disabled. Furthermore, a vibration prompt frequency can also be reduced to further avoid harm to the animal, and the content of the sound emission can also be changed to a soothing tune. The device 100 can monitor the health status of the animal and notify the user to perform corresponding actions to improve the overall health level of the animal.

The device 100 further includes the environment monitoring module 107 that is configured to acquire environment data of an environment that the animal is located in. The environment data includes the temperature and humidity of the environment. Manners of acquiring the temperature and humidity of the environment generally include using sensors and measurement devices. In this embodiment, the main control module 104 can further receive environment data. Therefore, the main control module 104 can also be configured to generate correction operations and correction intensity based on the environment data. When at least one of the temperature and the humidity of the environment are greater than a preset value, the correction intensity is reduced. Specifically, in a hot and humid weather, animals feel uncomfortable and are prone to illness and agitation. The animal behavior correction device 100 determines whether or not the temperature and the humidity reach a certain threshold based on data acquired by temperature and humidity sensors. When an electric shock operation is required, the voltage and the frequency of the electric shock are automatically reduced in a hot and/or humid weather. For example, in a weather of normal humidity and temperature, for animals having a normal weight, a voltage of from 5 kV to 15 kV is selected and 4 discharges are performed for each electric shock operation. For animals having a low weight, a voltage of from 3 kV to 9 kV is selected and 2 discharges are performed for each electric shock operation. In addition, in a hot and dry weather, for animals having a normal weight, a voltage of from 4 kV to 12 kV is selected and 4 discharges are performed for each electric shock operation. For animals having a low weight, a voltage of from 2 kV to 6 kV is selected and 2 discharges are performed for each electric shock operation. Naturally, the electric shock operation is disabled for sick or pregnant animals.

In certain embodiments, the device 100 further includes the camera 109 and the microphone 110 configured to acquire photos and sounds of the animal for determining the type of the animal. The device 100 is generally a ring-shaped collar. After the collar is put on the animal, the camera 109 on a lateral side of the collar can obtain a photo of the animal, and the microphone 110 can record a sound of the animal. Afterwards, the main control module 104 can acquire data of the photo and the sound of the animal, analyze the data to obtain the type of the animal, and then store the type of the animal in the basic data of the animal.

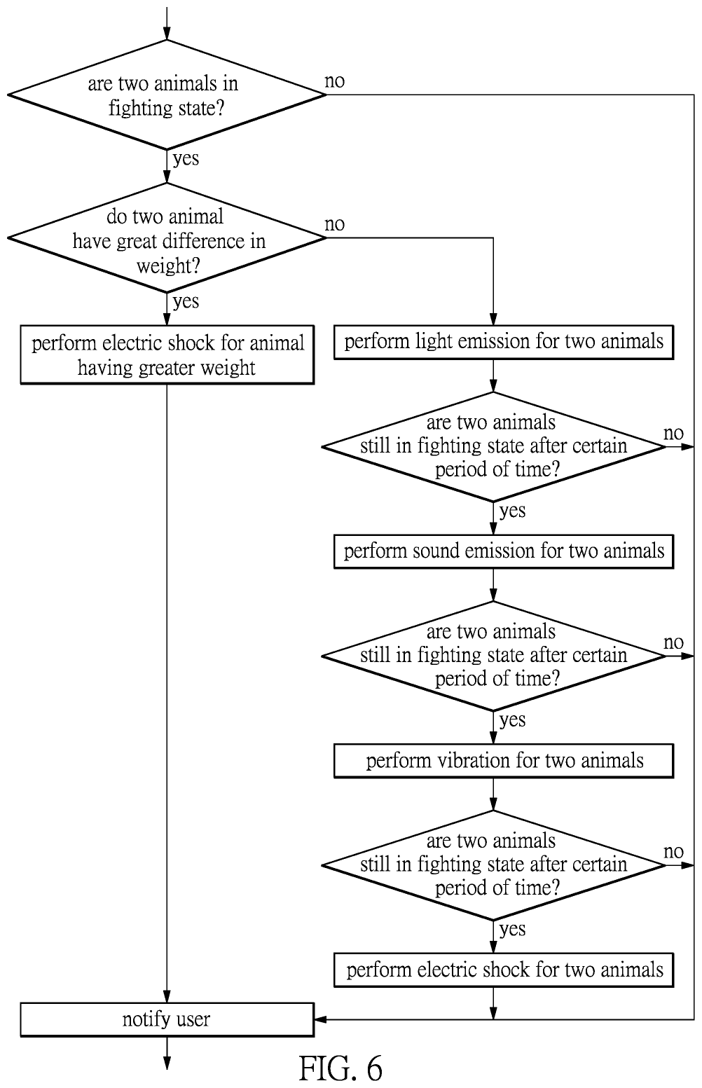

FIG. 6 is a flowchart of an animal behavior correction method for animal fighting according to the present disclosure. As shown in FIG. 1 to FIG. 3 and FIG. 6, the main control module 104 is further configured to determine that two of the animals are in a fighting state when changes in the movement paths of the two animals are identical within a same period of time, changes in the accelerations of the two animals within the same period of time are greater than a preset value, and the heartbeat frequencies of the two animals are all increased by a magnitude greater than a preset value. The correction operation is then configured to be the sound emission, the vibration, or the electric shock. This embodiment refers to correction of a fighting behavior of animals, which can occur outside the electronic fence or within the electronic fence. The fighting behavior can occur between two or more animals. Specifically, if two animals are in a fighting state, the two animals need to be corrected. A specific manner of correction includes the following steps. Firstly, whether or not a size difference between the two animals is too great is determined; specifically, the determination can be performed by acquiring the types and the weights of the two animals. The correction module 105 directly performs the electric shock operation on the larger animal, and does not perform the electric shock operation on the smaller animal. The correction module 105 performs a light emission operation, the communication module 108 transmits the location data of the two animals and a fighting notification to the server terminal 200, and the server terminal 200 then transmits or directly sends the location data of the two animals and the fighting notification to the user terminal 300.

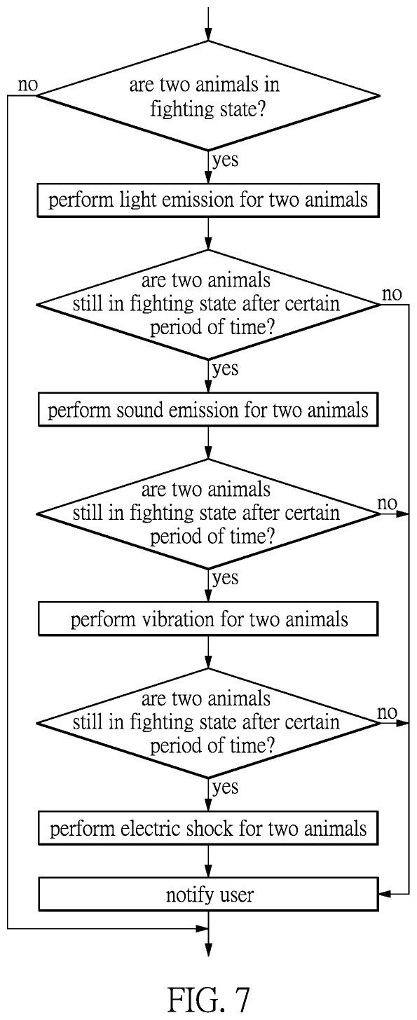

FIG. 7 is another flowchart of the animal behavior correction method for animal fighting. In other scenarios, multiple pets are fighting in a home environment. The positioning module 101 acquires location data of the animals, the positioning module 101 can achieve a confirmation of relative positions between multiple animal behavior correction devices 100 through Bluetooth®. An indoor space may be too small and include multiple obstructions, such that the accuracy of satellite positioning may be insufficient for such scenarios, and the Bluetooth® positioning technology can be used to address the aforementioned issues.

As shown in FIG. 1 to FIG. 3, the animal behavior correction device 100 further includes the communication module 108 that is configured to transmit at least the first location data, the basic data, and the physiological data of the animal, and the correction operation and the correction intensity through a communication system to the server terminal 200, and the server terminal 200 then transmits the above information to the user terminal 300. On the other hand, the communication module 108 can directly transmit the information to the user terminal 300. In the scenario of smart animal husbandry, when a type of an animal needs to be determined, the animal behavior correction device 100 transmits a photo of the animal acquired by the camera 109 and a sound of the animal recorded by the microphone 110 to the server terminal 200 through the communication module 108. The server terminal 200 performs analysis and returns the type of the animal to the device 100. The first communication system may adopt a cellular network or a Wi-Fi® network. When a distance between two animals in a parent-child relationship is greater than a preset value, the two animals in the parent-child relationship are determined to be in a missing state. The communication module 108 at least transmits the electronic identification and the first location data of the two animals in the parent-child relationship, and the communication module 108 transmits a notification regarding the two animals in the parent-child relationship to the server terminal 200 or the user terminal 300.

Accordingly, as shown in FIG. 3, another aspect of the present disclosure provides an animal behavior correction method, and the animal behavior correction method includes the following steps. Step S110 includes: acquiring the first location data of the animal and defining the second location data of the safe area. Step S120 includes: acquiring the basic data of the animal. Step S130 includes: acquiring the physiological data of the animal. Step S140 includes: determining whether or not the animal is located in the safe area based on the first location data of the animal and the second location data of the safe area, and generating the correction operation and the correction intensity of the correction operation at least based on the basic data and the physiological data when the animal is determined to not be located in the safe area. Step S150 includes: correcting the animal based on the correction operation and the correction intensity, such that the animal at least returns to the safe area.

FIG. 9 is a schematic view of an animal behavior correction system according to the present disclosure. As shown in FIG. 9, another aspect of the present disclosure provides an animal behavior correction system. The animal behavior correction system includes the animal behavior correction device 100, the server terminal 200, and the user terminal 300. The animal behavior correction device 100 acquires the first location data, the basic data, and the physiological data of the animal, and defines the second location data of the safe area. The animal behavior correction device 100 determines whether or not the animal is located in the safe area based on the first location data of the animal and the second location data of the safe area, and generates a correction operation and a correction intensity of the correction operation at least based on the basic data and the physiological data when the animal is determined to not be located in the safe area. The animal behavior correction device 100 then corrects the animal based on the correction operation and the correction intensity, such that the animal at least returns to the safe area. Afterwards, the animal behavior correction device 100 transmits at least the first location data, the basic data, the physiological data, the correction operation, and the correction intensity of the animal to the server terminal 200 through a first communication system, and the server terminal 200 then transmits the first location data, the basic data, the physiological data, the correction operation, and the correction intensity. The user terminal 300 receives the first location data, the basic data, the physiological data, the correction operation, and the correction intensity from the server terminal 200.

In conclusion, in the animal behavior correction device, method, and system provided by the present disclosure, by obtaining data such as locations and physiological state of the animal, when the animal leaves a range of an electronic fence, corresponding correction operation and correction intensity can be generated to keep the animal within the range of the electronic fence, thereby eliminating the need to install a physical fence and saving costs in animal husbandry. In addition, by monitoring a movement of the animal, corresponding correction operation and correction intensity can be generated for a fighting behavior of among the animals, thereby reducing casualty of the animals and animal husbandry costs. Furthermore, in the present disclosure, the health of the animal can also be monitored for improving the health of the animal.

What is claimed is:

1. An animal behavior correction device being worn on an animal to be detected, comprising:
a positioning module configured to acquire first location data of the animal and define second location data of a safe area;
a memory module configured to acquire basic data of the animal;
a physiological data acquisition module configured to acquire physiological data of the animal;
a main control module configured to determine whether or not the animal is located in the safe area based on the first location data of the animal and the second location data of the safe area, wherein, when the animal is not located in the safe area, the main control module generates a correction operation and a correction intensity of the correction operation based on at least the basic data and the physiological data; and
a correction module configured for behavioral correction of the animal based on the correction operation and the correction intensity, so as to at least return the animal to the safe area.

2. The animal behavior correction device according to claim 1, wherein the basic data includes a type, an age, a gender, an electronic identification, and a weight of the animal;
wherein, when the weight of the animal is detected to be less than a first preset value, the main control module is further configured to select a mild correction operation and reduce the correction intensity.

3. The animal behavior correction device according to claim 2, wherein the physiological data includes a heartbeat frequency and a number of swallows of the animal;
wherein the correction operation includes a light emission, a sound emission, a vibration, and an electric shock.

4. The animal behavior correction device according to claim 3, further comprising:
a movement monitoring module configured to acquire movement data of the animal, wherein the movement data includes a movement path and an acceleration of the animal;
wherein the main control module is further configured to generate the correction operation and the correction intensity based on the movement data.

5. The animal behavior correction device according to claim 4, wherein the main control module is further configured to determine that the animal is in a sick state and disable the electric shock in the correction operation in response to the weight of the animal decreasing by more than a second preset value within a first preset time, the number of swallows being less than a third preset value within a second preset time, and a length of the movement path being less than a fourth preset value within a third preset time.

6. The animal behavior correction device according to claim 4, wherein the main control module is further configured to determine that the animal is in a pregnant state and disable the electric shock in the correction operation in response to the animal being female, the weight of the animal increasing by more than a fifth preset value within a fourth preset time, the number of swallows being greater than a sixth preset value within a fifth preset time, and a length of the movement path being less than a seventh preset value within a sixth preset time.

7. The animal behavior correction device according to claim 4, further comprising:
an environment monitoring module configured to acquire environment data of an environment that the animal is located in, wherein the environment data includes a temperature and a humidity of the environment;
wherein the main control module is further configured to generate the correction intensity based on the environment data and reduce the correction intensity when at least one of the temperature and the humidity of the environment is greater than an eighth preset value.

8. The animal behavior correction device according to claim 7, further comprising:
a communication module configured to transmit at least the first location data, the basic data, the physiological data, the correction operation, and the correction intensity of the animal to a server terminal through a first communication system, wherein the server terminal then transmits the first location data, the basic data, the physiological data, the correction operation, and the correction intensity to a user terminal.

9. The animal behavior correction device according to claim 8, wherein the main control module is further configured to obtain a first determination result when changes in the movement paths of a plurality of animals are identical in a same period of time, changes in the accelerations of the plurality of animals in the same period of time are all greater than a ninth preset value, and the heartbeat frequencies of the plurality of animals are all increased by a magnitude greater than a tenth preset value; wherein the first determination result indicates that the plurality of animals are in a fighting state, and the correction operation is configured to be the sound emission, the vibration, or the electric shock.

10. The animal behavior correction device according to claim 9, wherein the communication module is further configured to transmit the first determination result, and the electronic identifications and the first location data of the plurality of animals to the server terminal through the first communication system when the plurality of the animals are determined to be in the fighting state; wherein the server terminal then transmits the first determination result, and the electronic identifications and the first location data of the plurality of animals to the user terminal.

11. The animal behavior correction device according to claim 1, further comprising:
a camera; and
a microphone, wherein the camera and the microphone are respectively configured to obtain a photo and a sound of the animal for determining a type of the animal;
wherein the main control module is further configured to generate the correction intensity based on the type of the animal, and select the correction operation and the correction intensity based on the type of the animal.

12. An animal behavior correction method, comprising processes of:
acquiring first location data of an animal and defining second location data of a safe area;
acquiring basic data of the animal;
acquiring physiological data of the animal;
determining whether or not the animal is located in the safe area based on the first location data of the animal and the second location data of the safe area, and generating a correction operation and a correction intensity of the correction operation at least based on the basic data and the physiological data when the animal is determined to not be located in the safe area; and
correcting behavior of the animal based on the correction operation and the correction intensity, such that the animal at least returns to the safe area.

13. An animal behavior correction system, comprising:
an animal behavior correction device acquiring first location data, basic data, and physiological data of an animal and defining second location data of a safe area, wherein the animal behavior correction device is configured to:
determine whether or not the animal is located in the safe area based on the first location data of the animal and the second location data of the safe area, and generate a correction operation and a correction intensity of the correction operation at least based on the basic data and the physiological data when the animal is determined to not be located in the safe area; and
correct behavior of the animal based on the correction operation and the correction intensity, such that the animal at least returns to the safe area;
a server terminal, wherein the animal behavior correction device transmits at least the first location data, the basic data, the physiological data, the correction operation, and the correction intensity of the animal to the server terminal through a first communication system, and the server terminal then transmits the first location data, the basic data, the physiological data, the correction operation, and the correction intensity; and
a user terminal, wherein the user terminal receives the first location data, the basic data, the physiological data, the correction operation, and the correction intensity from the server terminal.
